(19) United States
(12) Patent Application Publication
(10) Pub. No.: US 2015/0210156 A1
(43) Pub. Date: Jul. 30, 2015

(54) SYSTEM AND METHOD FOR COOLING ENGINE COMPONENT

(71) Applicant: Caterpillar Inc., Peoria, IL (US)

(72) Inventors: Avinash R. Manubolu, Edwards, IL (US); Vivekanandhan Sundararaj, Peoria, IL (US); Rustin G. Metzger, Congerville, IL (US)

(73) Assignee: Caterpillar Inc., Peoria, IL (US)

(21) Appl. No.: 14/164,501

(22) Filed: Jan. 27, 2014

(51) Int. Cl. B60K 11/02; E21C 35/00

(52) U.S. Cl. CPC B60K 11/02; E21C 35/00

(57) ABSTRACT

A method for controlling a plurality of fans associated with a cooling package is provided. The method includes providing a first airflow through a first heat exchanger using a first fan. The method includes regulating a speed of the first fan. The method also includes providing a second airflow through a second heat exchanger using a second fan. The second heat exchanger is spaced apart from the first heat exchanger. The method further includes regulating a speed of the second fan. The regulation of the speed of the second fan is configured to control a recirculation of at least a portion of the first airflow through the second fan.

### TECHNICAL FIELD

The present disclosure relates to a system and method for cooling an engine component, and more specifically to a system and method for cooling one or more heat exchangers associated with a machine.

### BACKGROUND

Mining machines include one or more components associated with an engine that may heat during operation. These heated components are required to be cooled. Hence, the mining machines may include one or more heat exchangers associated with the heated components. The heat exchangers are configured to receive heat from the heated components and cool the heated components. During this process, the heat exchangers may in turn get heated and may require to be cooled. Accordingly, a cooling module including one or more fans may be provided in association with the heat exchangers for cooling the heat exchangers.

U.S. Pat. No. 6,401,801 discloses a cooling system for cooling heat transfer devices in a work machine. The cooling system includes a pair of radial fans positioned vertically one on top of the other. The cooling system includes a first heat transfer device positioned upstream from the pair of fans. The cooling system includes a second heat transfer device positioned adjacent to and downstream from one side of the pair of fans. The cooling system includes a third heat transfer device positioned adjacent to and downstream from the opposite side of the pair of fans. The cooling system includes a downstream shroud positioned around the pair of fans for guiding the flow of air expelled therefrom to the second and third heat transfer devices. The pair of fans is configured to create an air flow through the first, second and third heat transfer devices.

### SUMMARY OF THE DISCLOSURE

In one aspect of the present disclosure, a method for controlling a plurality of fans associated with a cooling package is provided. The method includes providing a first airflow through a first heat exchanger using a first fan. The method includes regulating a speed of the first fan. The method also includes providing a second airflow through a second heat exchanger using a second fan. The second heat exchanger is spaced apart from the first heat exchanger. The method further includes regulating a speed of the second fan. The regulation of the speed of the second fan is configured to control a recirculation of at least a portion of the first airflow through the second fan.

In another aspect, a fan module for a cooling package of an engine is provided. The fan module includes a first fan associated with a first heat exchanger. The first fan is configured to operate at a speed and provide a first airflow therethrough. The fan module also includes a second fan associated with a second heat exchanger. The second fan is disposed spaced apart from the first fan. The second fan is configured to operate at a speed and provide a second airflow therethrough. The operation of the second fan is configured to control a recirculation of at least a portion of the first airflow through the second fan.

In yet another aspect, a mining machine is provided. The mining machine includes an engine. The mining machine includes a work tool. The mining machine includes a first heat exchanger associated with the engine. The mining machine includes a second heat exchanger associated with the engine. The mining machine also includes an air inlet. The mining machine further includes a fan module in fluid communication with the first heat exchanger and the second heat exchanger. The fan module includes a first fan associated with the first heat exchanger. The first fan is configured to operate at a speed and provide a first airflow therethrough. The fan module also includes a second fan associated with the second heat exchanger. The second fan is disposed spaced apart from the first fan. The second fan is configured to operate at a speed and provide a second airflow therethrough. The operation of the second fan is configured to control a recirculation of at least a portion of the first airflow through the second fan.

Other features and aspects of this disclosure will be apparent from the following description and the accompanying drawings.

### BRIEF DESCRIPTION OF THE DRAWINGS

FIG. 1 is a perspective view of an exemplary mining machine, according to one embodiment of the present disclosure;

FIG. 2 is a schematic representation of an airflow through an exemplary embodiment of a cooling module of the exemplary mining machine;

FIG. 3 is a perspective view of the exemplary embodiment of the cooling module; and

FIG. 4 is a flowchart of an exemplary method of cooling an engine component, according to one embodiment of the present disclosure.

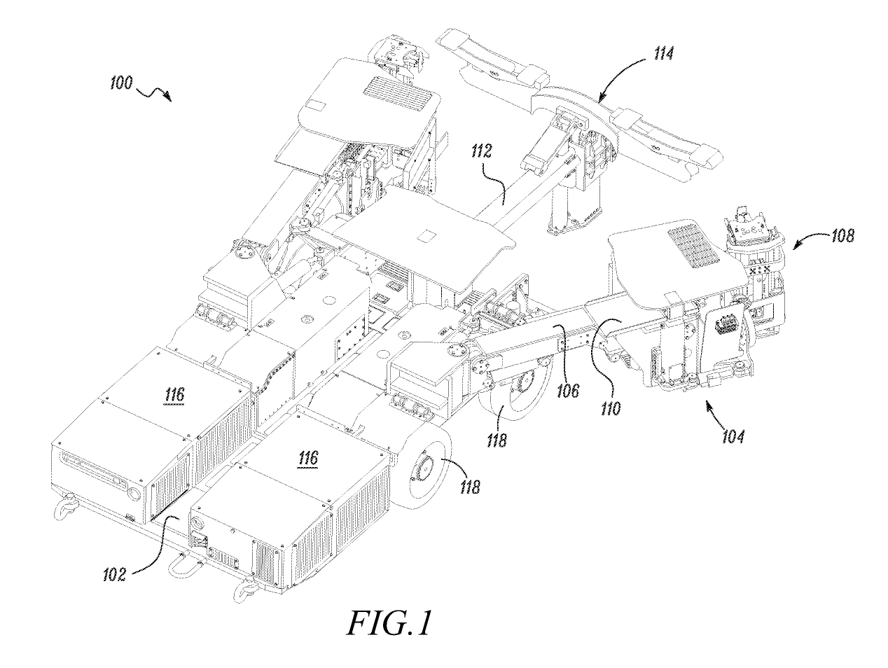

### DETAILED DESCRIPTION

Wherever possible, the same reference numbers will be used throughout the drawings to refer to the same or the like parts. Referring to FIG. 1, an exemplary embodiment of a mining machine 100 is illustrated. More specifically, as illustrated, the exemplary embodiment of the mining machine 100 is a roof bolter, however, one of ordinary skill in the art will appreciate that the mining machine 100 may be embodied by a plurality of non-illustrated alternative mining machines such as a mining transport machine, an ore transport machine and other similar machines. The mining machine 100 is configured to support a section of a roof of a mine and/or a tunnel during a roof bolting operation. The mining machine 100 is also configured to perform the roof bolting operation using suitable rock drilling and bolting tools. It should be noted that the mining machine 100 may include any other mining machine. For example, the mining machine 100 may embody a mining truck, a longwall miner, a continuous miner and so on.

The mining machine 100 includes a frame 102. The frame 102 is configured to mount and/or support various components of the mining machine 100. The mining machine 100 includes a drill boom assembly 104 pivotally coupled to the frame 102. The drill boom assembly 104 includes an arm 106 in order to pivotally couple the drill boom assembly 104 to the frame 102. The drill boom assembly 104 includes a drill assembly 108. The drill assembly 108 is configured to perform the rock bolting operation using suitable rock drilling and bolting tools. The drill boom assembly 104 includes an operator platform 110. The operator platform 110 is provided with various controls which may be used by an operator to control the drill boom assembly 104 and/or the mining machine 100.

It should be noted that the drill boom assembly 104 may be replaced by any other implement such as, a bucket, a hammer and so on as per operational requirements. The mining machine 100 includes a horizontal boom 112 pivotally coupled to the frame 102. A support member, such as an Automatic Temporary Roof Support (ATRS) 114, is provided on the horizontal boom 112. The horizontal boom 112 is configured as a telescopic boom having an extendable length in order to allow positioning of the ATRS 114 at a required location and distance with respect to the frame 102 of the mining machine 100 within the mine The ATRS 114 is configured to support a section of the mine during the drilling and/or roof bolting operation.

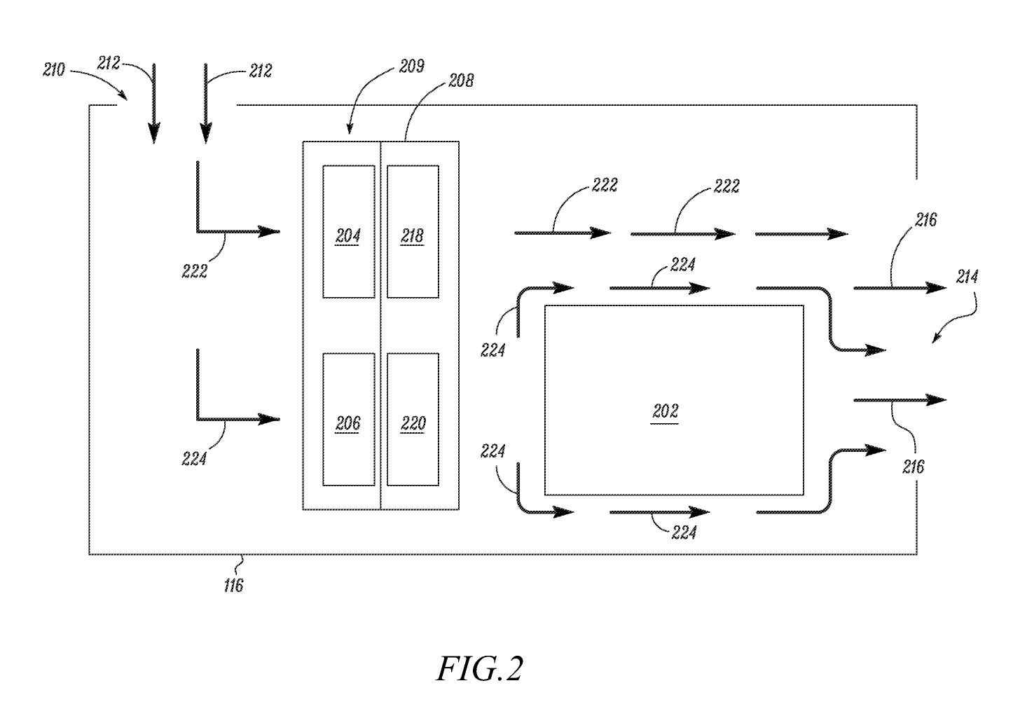

The mining machine 100 includes an enclosure 116 provided on the frame 102. Referring to FIG. 2, the enclosure 116 includes an engine 202, a first heat exchanger 204, a second heat exchanger 206 and a fan module 208 which will be explained in greater detail as follows. The first heat exchanger 204, the second heat exchanger 206 and the fan module 208 together may be referred to as a cooling package 209. The engine 202 may be any internal combustion engine known in the art and powered by a fuel such as gasoline, diesel, natural gas and/or a combination thereof. The engine 202 is configured to provide power to the mining machine 100 for mobility and/or other operational needs. The enclosure 116 may also house various other components required for operational control of the mining machine 100 including, but not limited to, electrical and/or electronic components, hydraulic and/or pneumatic components.

Referring to FIG. 1, the mining machine 100 includes locomotive means 118 such as wheels or tracks provided for the purpose of tramming the mining machine 100. A drivetrain (not shown) may be coupled to the engine 202 and the locomotive means 118. The drivetrain may include any one or a combination of, but not limited to, gearing, differentials, drive shafts and hydraulic and/or pneumatic circuits including motors, valves, lines, distribution manifolds and so on. The drivetrain may be configured to transmit power from the engine 202 to the locomotive means 118.

Referring to FIG. 2, the enclosure 116 includes an air inlet 210. The air inlet 210 is configured to provide an intake of air from atmosphere into the enclosure 116 as shown by an arrow 212. Further, the enclosure 116 includes an air outlet 214. The air outlet 214 is configured to provide an exit for the air from the enclosure 116 to the atmosphere or other section and/or system of the mining machine 100 as shown by an arrow 216.

The enclosure 116 includes the first and second heat exchangers 204, 206 configured to transfer heat between the air flowing over the first and second heat exchangers 204 and 206 and one or more fluids contained therein. The first and second heat exchangers 204, 206 are independent components with respect to each other and may receive different fluids therein. More specifically, the first heat exchanger 204 is provided in fluid communication with a hydraulic circuit (not shown) of the mining machine 100 such that it receives a hydraulic fluid therefrom. The hydraulic circuit may be configured to power an implement arrangement, for example, the drill boom assembly 104 and/or the drill assembly 108 of the mining machine 100. The first heat exchanger 204 is configured to cool the hydraulic fluid of the hydraulic circuit by allowing transfer of heat between the hydraulic fluid and the air. The hydraulic fluid may be utilized for operational requirements of the mining machine 100 such as for mobility of the drill boom assembly 104 and/or the drill assembly 108.

The second heat exchanger 206 is provided in fluid communication with a cooling circuit (not shown) of the engine 202 and/or the mining machine 100 such that it receives an engine coolant fluid therefrom. The second heat exchanger 206 is configured to cool the engine coolant of the cooling circuit by allowing transfer of heat between the engine coolant and the air. The engine coolant may be configured to absorb excess heat generated by the engine 202 and/or other engine components. In one embodiment, the first and second heat exchangers 204, 206 may be interchanged such that the first heat exchanger 204 may receive the engine coolant and the second heat exchanger 206 may receive the hydraulic fluid.

The first heat exchanger 204 is spaced apart from the second heat exchanger 206. In the illustrated embodiment, the first and second heat exchangers 204, 206 are positioned in a vertical configuration such that the first heat exchanger 204 is positioned above the second heat exchanger 206. Further, the first and second heat exchangers 204, 206 are coplanar. The arrangement of the first and second heat exchangers 204, 206 described herein is exemplary. In another embodiment, the first and second heat exchangers 204, 206 may be positioned in a horizontal configuration such that the first heat exchanger 204 may be positioned besides the second heat exchanger 206. In yet another embodiment, the first and second heat exchangers 204, 206 may be integrated to form a single component.

The present disclosure relates to the fan module 208 provided within the enclosure 116. More specifically, the fan module 208 is disposed between and in fluid communication with the first and second heat exchangers 204, 206, the air inlet 210 and the air outlet 214 of the enclosure 116. The fan module 208 includes a first fan 218 and a second fan 220. The first fan 218 is spaced apart from the second fan 220. The first and second fans 218, 220 are provided in a vertical configuration such that the first fan 218 is positioned above the second fan 220. Further, the first and second fans 218, 220 are coplanar. In another embodiment, the first and second fans 218, 220 may be provided in an inclined or a horizontal configuration and/or in a non-coplanar arrangement.

The fan module 208 is provided in cooperation with the first and second heat exchangers 204, 206 such that the fan module 208 is coupled to the first and second heat exchangers 204, 206. The fan module 208 is disposed adjacent to and spaced apart from the first and second heat exchangers 204, 206. Accordingly, the first and second fans 218, 220 are provided in fluid communication with the first and second heat exchangers 204, 206 respectively. The first fan 218 is configured to provide a first airflow 222 through the first heat exchanger 204. The second fan 220 is configured to provide a second airflow 224 through the second heat exchanger 206 such that the second airflow 224 is parallel to the first airflow 222.

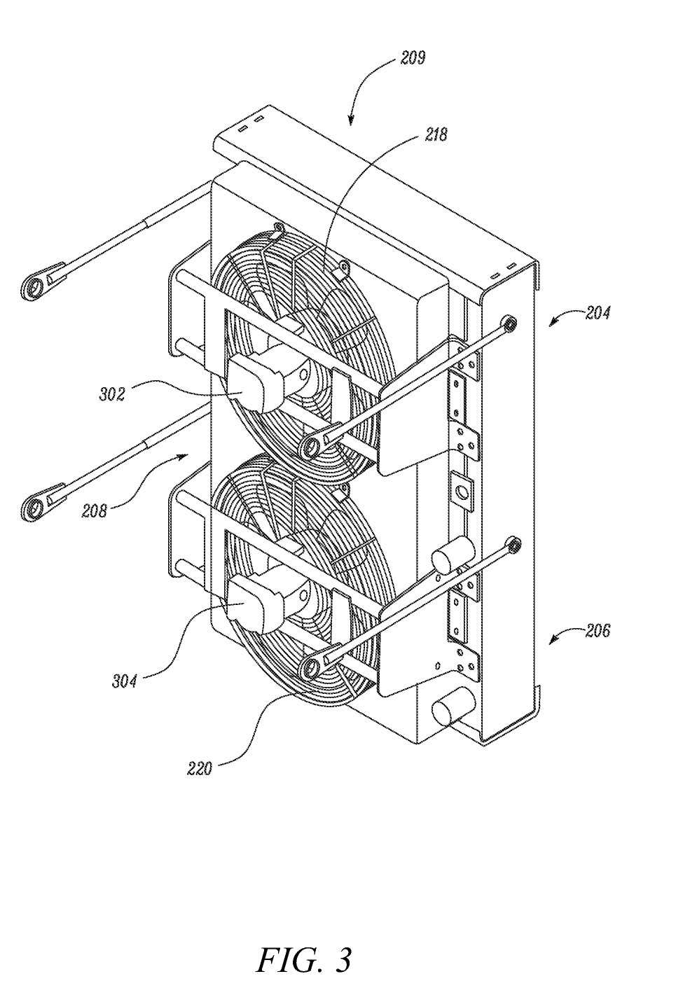

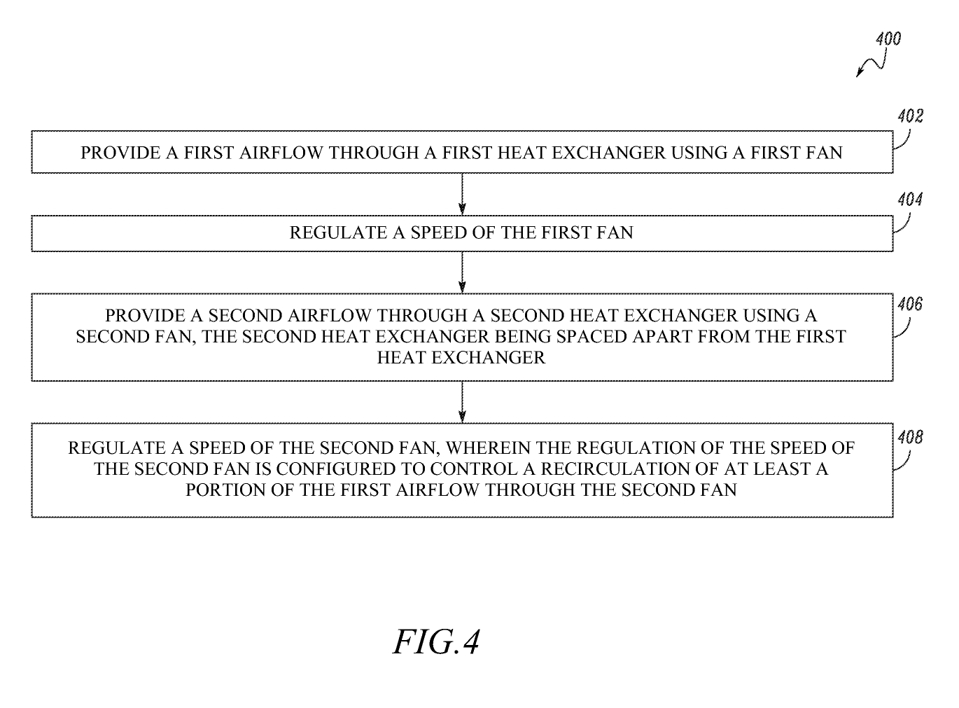

Referring to FIG. 3, a perspective view of the fan module 208 is illustrated. The fan module 208 includes a first motor 302 coupled to the first fan 218. The first motor 302 is configured to operate the first fan 218 at a speed S1. The fan module 208 also includes a second motor 304 coupled to the second fan 220. The second motor 304 is configured to operate the second fan 220 at a speed S2. The speed S2 is configured to control a recirculation of at least a portion of the first airflow 222 through the second fan 220 when the engine 202 may be turned off and will be explained in detail with reference to FIG. 4.

The first and second motors 302, 304 may be any motors known in the art including, but not limited to, a hydraulic motor, an electric motor and/or a combination thereof. The second motor 304 is independent of operation with respect to the first motor 302. Accordingly, the speeds S1, S2 may be equal to or different from each other based on an operational status of the fan module 208 and/or the mining machine 100.

The mining machine 100 may include a controller (not shown). The controller may be communicably coupled to the first and second motors 302, 304. The controller may be configured to independently regulate the first and second fans 218, 220 at the speeds S1, S2 respectively. The independent regulation of the speeds S1, S2 may be performed by the controller by any known methods of speed regulation known to one skilled in the art. The controller may regulate the first and second fans 218, 220 at the speeds S1, S2 based on one or more operational parameters of the mining machine 100, including, but not limited to, engine speed, engine torque, machine speed, machine load and power delivery to the implement arrangement.

The controller may embody a single microprocessor or multiple microprocessors that includes a means for receiving signals from the components of the fan module 208 and/or the mining machine 100. Numerous commercially available microprocessors may be configured to perform the functions of the controller. It should be appreciated that the controller may readily embody a general machine microprocessor capable of controlling numerous machine functions. A person of ordinary skill in the art will appreciate that the controller may additionally include other components and may also perform other functionality not described herein. It should be understood that the embodiments and the configurations and connections explained herein are merely on an exemplary basis and may not limit the scope and spirit of the disclosure.

### INDUSTRIAL APPLICABILITY

Some currently used mining machines utilize the cooling package having two cooling fans, that is, an engine cooling fan and a hydraulic oil cooling fan. The engine cooling fan and the hydraulic oil cooling fan are configured to operate at different speeds corresponding to different machine operating conditions. For example, during the drilling operation, the engine cooling fan may be turned off, whereas the hydraulic oil cooling fan may operate at maximum speed. In such a situation, the airflow from the hydraulic oil cooling fan may tend to recirculate and escape backwards towards an inlet of the cooling package through the engine cooling fan. This recirculation may cause a temperature of the airflow to a heat exchanger which is present upstream of the fans with respect to the airflow, to increase. The rise in temperature may in turn have an effect on an overall efficiency and performance of the cooling package.

The mining machine 100 is configured to operate in different operational modes. In a first operational mode, the mining machine 100 may be stationary with the implement arrangement turned on. In such an operational mode, the engine 202, the cooling circuit and the second fan 220 may be turned off Further, the implement arrangement, the hydraulic circuit and the first fan 218 may be turned on. In the first operational mode, power required for the implement arrangement may be provided to the mining machine 100 from a power source external to the mining machine 100 as the engine 202 may be turned off.

When the first fan 218 is turned on and the second fan 220 is turned off, the first airflow 222 may be provided through the first heat exchanger 204. As the second fan 220 is turned off, the second airflow 224 may be absent. In such a situation, a low pressure area may be generated on an upstream side of the second fan 220, between the air inlet 210 and the second fan 220, with respect to a downstream side of the first fan 218. This low pressure area may cause escape and recirculation of the first airflow 222 present on the downstream side of the first fan 218 through the second fan 220, and then through the second heat exchanger 206, and may return to re-enter the first fan 218. Such recirculation of the first airflow 222 may result in higher core temperature of the first heat exchanger 204 due to the repeated circulation of air which has already been heated by the first heat exchanger 204.

The present disclosure relates to a method for controlling a plurality of fans associated with the cooling package 209. Referring to FIG. 4, a flowchart of an exemplary method 400 for controlling the first and second fans 218, 220 is illustrated. At step 402, the first airflow 222 is provided through the first heat exchanger 204 using the first fan 218. The first airflow 222 is provided through the first heat exchanger 204 for cooling the first heat exchanger 204. At step 404, the first fan 218 is regulated by the controller at the speed S1. At step 406, the second airflow 224 is provided through the second heat exchanger 206 using the second fan 220. The second airflow 224 is parallel to the first airflow 222. The second heat exchanger 206 is spaced apart from the first heat exchanger 204.

At step 408, the second fan 220 is regulated by the controller at the speed S2. The regulation of the speed S2 is configured to control the recirculation of at least the portion of the first airflow 222 through the second fan 220. More specifically, the regulation of the speed S2 is configured to create a pressure balance between the upstream side and a downstream side of the second fan 220 resulting in a baffle for preventing the recirculation of the first airflow 222 through the second fan 220. In some embodiments, the speed S2 may be configured to reduce, minimize and/or prevent the recirculation of at least the portion of the first airflow 222 through the second fan 220 when the engine 202 may be turned off.

The mining machine 100 may have a second operational mode. In the second operational mode, the mining machine 100 may be tramming with the implement arrangement turned off. In the second operational mode, the engine 202, the cooling circuit and the second fan 220 may be turned on. Further, the hydraulic circuit and the first fan 218 may be turned off.

When the first fan 218 is turned off and the second fan 220 is turned on, the second airflow 224 may be provided through the second heat exchanger 206. As the first fan 218 is turned off, the first airflow 222 may be absent. In such a situation, a low pressure area may be generated on an upstream side of the first fan 218, between the air inlet 210 and the first fan 218, with respect to the downstream side of the second fan 220. This low pressure area may cause escape and recirculation of the second airflow 224 present on the downstream side of the second fan 220. This recirculated airflow may travel through the first fan 218, the first heat exchanger 204, and may further enter the second fan 220 to be circulated in to the enclosure 116 and repassed over the second heat exchanger 206. Such recirculation of the second airflow 224 may result in higher core temperature of the second heat exchanger 206 due to the repeated circulation of air which has already been heated by the second heat exchanger 206.

In the second operational mode, at step 402, the second airflow 224 may be provided through the second heat exchanger 206 using the second fan 220. The second airflow 224 may be provided through the second heat exchanger 206 for cooling the second heat exchanger 206. At step 404, the second fan 220 may be regulated by the controller at the speed S2. At step 406, the first airflow 222 may be provided by the first fan 218. The first airflow 222 is parallel to the second airflow 224.

At step 408, the first fan 218 may be regulated by the controller at the speed S1. The regulation of the speed S1 is configured to control the recirculation of at least a portion of the second airflow 224 through the first fan 218. More specifically, the regulation of the speed S1 may be configured to create a pressure balance between the upstream side and the downstream side of the first fan 218 resulting in a baffle for preventing the recirculation of the second airflow 224 through the first fan 218. In some embodiments, the speed S1 may be configured to reduce, minimize and/or prevent the recirculation of at least the portion of the second airflow 224 through the first fan 218 when the engine 202 may be turned on and the implement arrangement may be turned off.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method for controlling a plurality of fans associated with a cooling package, the method comprising:
providing a first airflow through a first heat exchanger using a first fan;
regulating a speed of the first fan;
providing a second airflow through a second heat exchanger using a second fan, the second heat exchanger being spaced apart from the first heat exchanger; and
regulating a speed of the second fan, wherein the regulation of the speed of the second fan is configured to control a recirculation of at least a portion of the first airflow through the second fan.

2. The method of claim 1, wherein the second airflow is parallel to the first airflow.

3. A fan module for a cooling package of an engine, the fan module comprising:
a first fan associated with a first heat exchanger, the first fan configured to operate at a speed and provide a first airflow therethrough; and
a second fan associated with a second heat exchanger, the second fan disposed spaced apart from the first fan, the second fan configured to operate at a speed and provide a second airflow therethrough,
wherein the operation of the second fan is configured to control a recirculation of at least a portion of the first airflow through the second fan.

4. The fan module of claim 3 further comprising:
a first motor coupled to the first fan.

5. The fan module of claim 4, wherein the first motor is at least one of a hydraulic motor and an electric motor.

6. The fan module of claim 3 further comprising:
a second motor coupled to the second fan.

7. The fan module of claim 6, wherein the second motor is at least one of a hydraulic motor and an electric motor.

8. The fan module of claim 3, wherein the speed of the second fan is lesser than the speed of the first fan.

9. The fan module of claim 3, wherein the second airflow is parallel to the first airflow.

10. A mining machine comprising:
an engine;
a work tool;
a first heat exchanger associated with the engine;
a second heat exchanger associated with the engine;
an air inlet; and
a fan module in fluid communication with the first heat exchanger and the second heat exchanger, the fan module comprising:
a first fan associated with the first heat exchanger, the first fan configured to operate at a speed and provide a first airflow therethrough; and
a second fan associated with the second heat exchanger, the second fan disposed spaced apart from the first fan, the second fan configured to operate at a speed and provide a second airflow therethrough,
wherein the operation of the second fan is configured to control a recirculation of at least a portion of the first airflow through the second fan.

11. The mining machine of claim 10 further comprising:
a first motor coupled to the first fan.

12. The mining machine of claim 11, wherein the first motor is at least one of a hydraulic motor and an electric motor.

13. The mining machine of claim 10 further comprising:
a second motor coupled to the second fan.

14. The mining machine of claim 13, wherein the second motor is at least one of a hydraulic motor and an electric motor.

15. The mining machine of claim 10, wherein the second speed is lesser than the first speed.

16. The mining machine of claim 10, wherein the second airflow is parallel to the first airflow.
